(19) United States
(12) Patent Application Publication
(10) Pub. No.: US 2019/0025181 A1
(43) Pub. Date: Jan. 24, 2019

(54) METHOD OF AND SYSTEM FOR DETERMINING TEXTURIZATION OF ROVINGS

(71) Applicant: OCV Intellectual Capital, LLC, Toledo, OH (US)

(72) Inventors: Kevin Herreman, Newark, OH (US); Ralph Jousten, Waterloo (BE); Frank Trasser, Saint Jean d'Arvey (FR); Mark A. Clites, Newark, OH (US); Stephane Mouret, Annecy (FR); Michelle Korwin-Edson, Granville, OH (US)

(73) Assignee: OCV Intellectual Capital, LLC, Toledo, OH (US)

(21) Appl. No.: 16/068,693

(22) PCT Filed: Jan. 5, 2017
(86) PCT No.: PCT/US2017/012246

§ 371 Date: Jul. 9, 2018

Related U.S. Application Data
(60) Provisional application No. 62/280,796, filed on Jan. 20, 2016.

(51) Int. Cl. G01N 15/08; G01N 15/02; F01N 1/24

(52) U.S. Cl. CPC G01N 15/0826; G01N 15/02; F01N 2310/02; G01N 2015/0294; F01N 1/24

(57) ABSTRACT

Methods of and systems for quantifying a degree of texturization of fibrous materials, such as muffler fill materials, are disclosed.

### CROSS REFERENCE TO RELATED APPLICATIONS

This application claims priority to and any benefit of U.S. Provisional Application No. 62/280,796, filed Jan. 20, 2016, the entire content of which is incorporated herein by reference.

### FIELD

The general inventive concepts relate to texturized fibrous material and, more particularly, to a method of and a system for accurately assessing a degree of texturization of the fibrous material.

### BACKGROUND

It is known to use texturized glass fibers in a muffler to absorb sound. For example, U.S. Pat. No. 4,569,471, the entire disclosure of which is incorporated herein by reference, discloses a method of and apparatus for filling a muffler with texturized glass fibers. According to the '471 patent, an apparatus comprises a feeder means 7 which advances a multifiber thread (e.g., a roving 2 of continuous glass fiber) to a nozzle 9 into which compressed air is blown to move the thread, while at the same time the fibers are blown apart and entangled so as to form continuous wool. The wool is blown directly into the muffler 13 while the blown-in air is evacuated by a suction fan 18.

Furthermore, it is desirable to measure or otherwise assess the degree of texturization of the glass fibers, for example, to gauge the acoustical performance of the material. Determining the degree of texturization could also be useful in evaluating changes in process variables on material performance.

Traditionally, the industry has relied on a test (i.e., the “Toyota Test”) to determine the degree of texturization of a fibrous material. As shown in FIG. 1, a conventional system 100 for implementing this test involves placing a quantity of texturized material 102 in a clear tube 104. Then, a piston 106 guides a disk 108 down onto the texturized material 102 to compress it, with the degree of compression being ascertainable by way of a ruler 110 or other indicia associated with the tube 104. The less the compression of the texturized material 102 within the tube 104, the greater the texturization of the material. In this manner, the test provides a general result representative of the difference between well and poorly texturized materials. However, this test has drawbacks such as its reliance on the person performing the test (e.g., visually gauging the results), the way the material is placed in the tube, and the ability of the piston to move slowly down the tube without pushing or binding the material in the tube, all of which could negatively impact the accuracy of the results.

### SUMMARY

It is proposed herein to provide a more accurate and consistent technique for determining the degree of texturization of a fibrous material. The fibrous material is typically a texturized fiber formed by impacting a roving with compressed air to separate the individual fibers forming said roving from one another. The proposed technique is based on measuring airflow resistivity and, in particular, the pressure drop across the fibrous material at a particular flow rate. The technique accounts for both the percentage of fibers separated from the roving and the entanglement of those fibers.

Accordingly, the general inventive concepts relate to and contemplate a method of and system for determining the texturization of a fibrous material.

According to an exemplary embodiment, a method of quantifying a degree of texturization of a fibrous material is provided. The method comprises: providing a quantity of the fibrous material in a chamber; introducing air into the chamber at a predetermine flow rate; measuring a drop in pressure across the fibrous material at the flow rate; using the drop in pressure to calculate an effective fiber diameter of the fibrous material; and using the effective fiber diameter to determine the degree of texturization of the fibrous material.

In some exemplary embodiments, the degree of texturization is expressed as a ratio of an actual fiber diameter of the fibrous material to the effective fiber diameter of the fibrous material. In some exemplary embodiments, the degree of texturization is expressed as a percentage calculated by multiplying the ratio by 100.

In some exemplary embodiments, the actual fiber diameter is within the range of 8 μm to 40 μm.

In some exemplary embodiments, the chamber is a production muffler. In some exemplary embodiments, the chamber is a reference muffler.

In some exemplary embodiments, the fibrous material is texturized fiberglass. In some exemplary embodiments, the texturized fiberglass is formed by feeding a fiberglass roving through a texturizing nozzle.

In some exemplary embodiments, the method further comprises feeding a fiberglass roving through a texturizing nozzle to form the fibrous material within a cavity of a muffler; and relocating at least a portion of the fibrous material from the cavity to the chamber.

In some exemplary embodiments, the quantity of the fibrous material in the chamber has a fill density within the range of 80 g/L to 200 g/L.

According to an exemplary embodiment, a system for quantifying a degree of texturization of a fibrous material is provided. The system comprises: first means for holding a quantity of the fibrous material; second means for drawing air through the fibrous material at a predetermined flow rate; third means for measuring a drop in pressure across the fibrous material at the flow rate; fourth means for calculating an effective fiber diameter of the fibrous material using the drop in pressure; and fifth means for determining the degree of texturization of the fibrous material using the effective fiber diameter.

In some exemplary embodiments, the first means is a production muffler. In some exemplary embodiments, the production muffler is modified to interface with the system. In some exemplary embodiments, an adaptor allows the production muffler to interface with the system. In some exemplary embodiments, the first means is a reference muffler.

In some exemplary embodiments, the second means comprises a vacuum pump, a flow valve, and a flow meter.

In some exemplary embodiments, the third means comprises a manometer.

In some exemplary embodiments, the fourth means is a general purpose computer programmed to solve the equation:

$${d}_{effective} = \sqrt{\frac{3180 * {ρ}^{1.53}}{{R}_{1 , ideal}}} .$$

In some exemplary embodiments, the fifth means is a general purpose computer programmed to solve the equation:

$$degree of texturization = \frac{{d}_{filament}}{{d}_{effective}} * 100.$$

In some exemplary embodiments, the general purpose computer includes a display, wherein the degree of texturization is displayed on the display.

In some exemplary embodiments, the fibrous material is texturized fiberglass. In some exemplary embodiments, the texturized fiberglass is formed by feeding a fiberglass roving through a texturizing nozzle.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

The general inventive concepts, as well as embodiments and advantages thereof, are described below in greater detail, by way of example, with reference to the drawings in which:

FIG. 1 is a diagram of a conventional apparatus for determining a degree of texturization of a fibrous material.

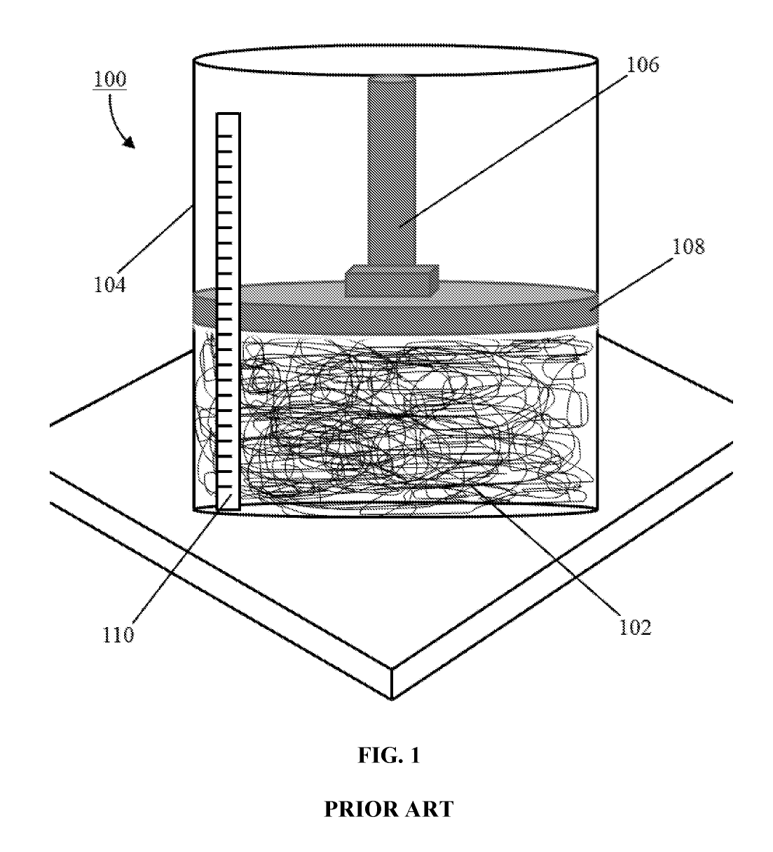

FIG. 2 is a flowchart of a method of determining a degree of texturization of a fibrous material, according to an exemplary embodiment.

FIG. 3 is a diagram of an apparatus for determining a degree of texturization of a fibrous material, according to an exemplary embodiment.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts encompass methods of and systems for determining the degree of texturization of a fibrous material, such as a texturized fiber. The texturized fiber may be formed by impacting a roving with compressed air to separate the individual fibers forming said roving from one another, as known in the art. As used herein, the word/phrase “texturized fiber” is defined as one or more strands (e.g., from a roving) wherein the fibers forming the strands are separated, such as by compressed air, into individual fibers to give the fibers a “fluffed-up” or wool-like appearance. The fibers can be “texturized” by any suitable means, such as through mechanical handling of the fibers.

In some exemplary embodiments the fibers are glass fibers. In some exemplary embodiments, each of the fibers making up the roving has approximately the same diameter. In some exemplary embodiments, the diameter of the fibers making up the roving is within the range of 8 μm to 40 μm. In the case of glass fibers, the diameter of the fibers is generally related, at least in part, to a size (e.g., diameter) of orifices on a bushing through which the fibers are formed. In some exemplary embodiments, a diameter of the orifices on the bushing is within the range of 8 μm to 40 μm.

The methods of and systems for determining the degree of texturization of a texturized fiber involve measuring airflow resistivity and, in particular, the pressure drop across the texturized fiber at a particular flow rate. In this manner, both the percentage of fibers separated from the roving and the entanglement of those fibers can be ascertained.

For purposes of better illustrating various aspects of the general inventive concepts, and not for purposes of limiting same, a method of determining the degree of texturization of a texturized glass fiber for use in a muffler (silencer) will now be described.

A fiberglass roving is made of continuous fibers (filaments) wound onto a doff (bobbin). A typical doff contains up to four kilometers of continuous fibers. Those fibers are collected during the manufacturing process, coated with a binder, then brought together to form the fiberglass roving. For example, the texturized fiber sold by Owens Corning of Toledo, Ohio under the brand name Silentex®, which is suitable for use in most muffler applications, is formed by texturizing a fiberglass roving. The texturized fiber is used to fill cavities in a muffler. The texturized fiber can be introduced into the muffler in any suitable manner. For example, the texturized fiber can be directly injected into a muffler chamber, into a bag, into a box, or alternatively into a mold to produce a preformed semi-rigid part that can then be inserted into a muffler. Once packed into the cavities of the muffler, the texturized fiber performs well as a noise reduction material, for example, in a range from 120 to 150 grams per liter (g/L) density.

As described herein, texturization is the separation of the roving into the individual fibers that make up the roving. Greater texturization represents greater separation of the roving strand into individual fibers. A well texturized roving performs well as an absorber in a muffler without a potential for blow out of the material over time. A poorly texturized material exhibits “roping” or “clumping” of the fibers together, which reduces the ability of the material to absorb sound.

Porous materials, specifically fibrous materials, provide absorption of sound waves impacting the material. The action of this absorption is the conversion of the wave energy into heat. Because the energy contained in an acoustic wave is very small, the quantity of heat generated is also very small.

There are two basic mechanisms of sound absorption in materials, viscous flow loss and internal friction loss. Viscous flow losses occur when, during propagation of the acoustic wave, the particle velocity associated with the acoustic wave causes relative motion between the medium (air) and the surrounding material (absorber). Internal friction losses occur when the fibrous or porous structures are flexed by the acoustic wave propagation. Most fiberglass absorbers are considered to be rigid frame absorbers and therefore do not have the associated internal friction losses. As a result, boundary-layer losses occur within the structure similar to parasitic drag on the aerodynamic surfaces of an aircraft. Equation (1) shows the formula for determining airflow resistivity:

$${R}_{1 , ideal} = L O I * K * \frac{{ρ}^{1.53}}{{d}_{effective}^{2}} \qquad ( 1 )$$

where airflow resistivity, R₁ (mks Rayls/m), is the measure of the resistance within an acoustic material related to the amount of viscous flow loss of the material. The maximum amount of sound absorption that the material will be able to achieve is a function of its characteristic density ρ (kg/m³), effective (or mean) fiber diameter (d_{effective}), and loss on ignition (LOI). The value K is a constant with a value of 3,180 when the fiber diameter is measured in microns. The LOI is the ratio of the weight lost after the material is subjected to high heat to the original weight of the specimen plus one. For many texturized glass fibers, this ratio is often very small and the LOI can be assumed to have a value of one.

If the formula of equation (1) is solved for effective fiber diameter, the following equation (2) results.

$${d}_{effective} = \sqrt{\frac{3180 * {ρ}^{1.53}}{{R}_{1 , ideal}}} \qquad ( 2 )$$

Taking the ratio of the actual fiber diameter (d_{filament}) to the effective fiber diameter provides a percentage of texturization representing the average resulting fraction of fibers that were effectively separated from the roving. Then, multiplying by one hundred yields a percent of texturization, as obtained by the following equation (3).

$$\frac{{d}_{filament}}{{d}_{effective}} * 100 = \% Texturized \qquad ( 3 )$$

Applying this formula to airflow resistivity testing of a particular muffler (e.g., a reference muffler) yields a repeatable and accurate value representing the degree of texturization of a texturized fiber. Furthermore, this value can be utilized to identify the effect of changes to various process parameters, such as nozzle design, air pressure setting, sizing chemistry, and filament diameter on performance of the texturized fiber.

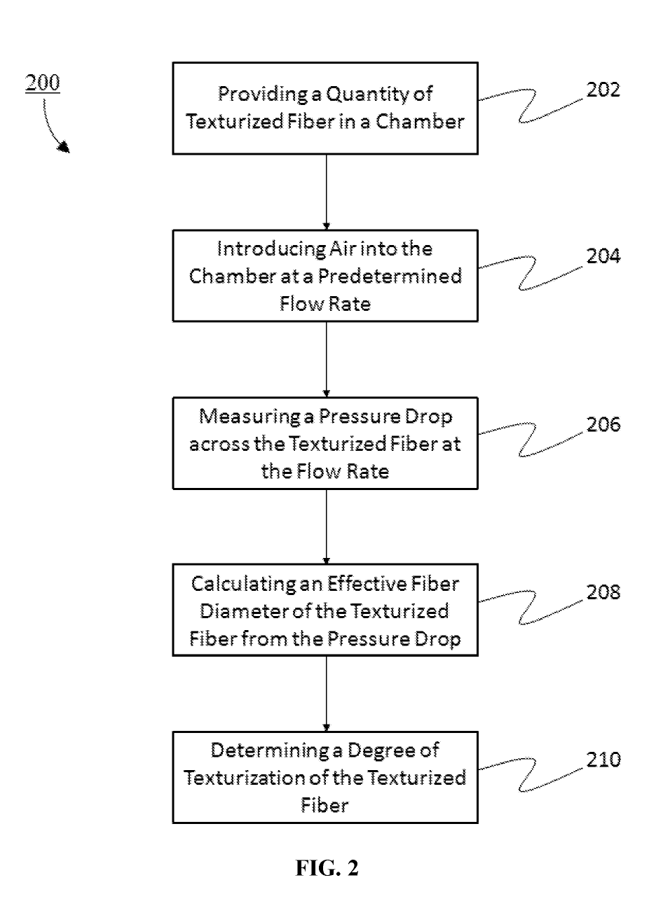

A method 200 of determining the texturization of a fiberglass roving for use in a muffler, according to one exemplary embodiment, will now be described with reference to FIG. 2. Initially, a quantity of the texturized fiber to be assessed is provided in step 202. In some exemplary embodiments, the amount of texturized fiber provided is within the range of 80 g/L to 200 g/L (fill density). The texturized fiber can be provided in any suitable manner. For example, the texturized fiber can be manually moved from a first location to a sample holder of the test station. The first location can be a test muffler (e.g., a reference muffler), an actual production muffler, or some other repository or package (e.g., a bag) of the fibrous material. Alternatively, the texturized fiber can be prepared and directly filled into the sample holder of the test station, or a reference or production muffler adapted for use in the test system. In this manner, a quantity of the texturized fiber having a known density ρ (kg/m³) is positioned within a test chamber, cavity, or the like of the test station to be assessed.

Next, in step 204, a source of air is introduced into the test chamber at a predetermined flow rate. As the air flows across the texturized fiber in the test chamber, a pressure drop is measured in step 206. This pressure drop represents the airflow resistivity (R₁) of the texturized fiber. With the density of the texturized fiber known and airflow resistivity of the texturized fiber determined, the effective fiber diameter (d_{effective}) is calculated in step 208 using equation (2). Finally, based on the effective fiber diameter (d_{effective}), the degree of texturization of the texturized fiber is calculated in step 210 using equation (3).

Thus, the method 200 provides a consistent, repeatable, and accurate (e.g., within +/−7%) measure of the texturization of a fibrous material.

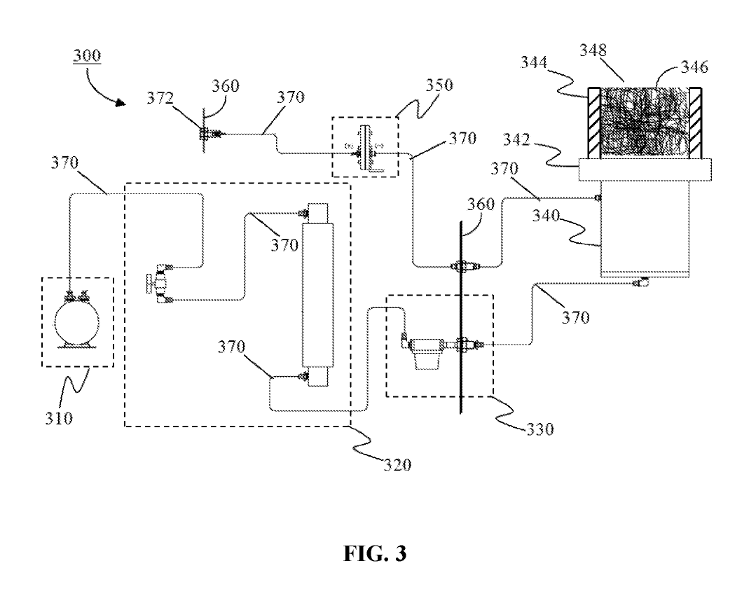

A system 300 for determining the texturization of a fiberglass roving for use in a muffler, according to one exemplary embodiment, will now be described with reference to FIG. 3. The system 300 includes various components including a vacuum pump 310, a flow regulator 320 (e.g., including a flow valve and a flow meter), a filter 330, a vacuum canister 340, and a manometer 350. Some or all of the components can be situated, at least in part, in a unitary housing (not shown) comprising a plurality of walls 360. The housing acts to protect the components and, in some embodiments, may allow the system to be readily movable from one location to another.

The vacuum canister 340 includes a support 342 for a sample holder. In some exemplary embodiments, the sample holder is a reference muffler 344. Unlike a production muffler, the reference muffler 344 was created for use in the system 300 and not for actual installation on a vehicle. The reference muffler 344 is a muffler-like body with predefined dimensions. The reference muffler 344 is designed to hold a quantity of fibrous material 346 and interface (e.g., via the support 342) with the vacuum canister 340. In some exemplary embodiments, the reference muffler 344 is able to accommodate the fibrous material 346 at a fill density of between 80 g/L to 200 g/L. In some exemplary embodiments, the fibrous material 346 is texturized fiberglass formed by texturizing a fiberglass roving. At least a portion (e.g., an upper portion 348) of the reference muffler 344 is open to the atmosphere (i.e., exposed to ambient pressure).

The vacuum pump 310, the flow regulator 320, the filter 330, the vacuum canister 340, and the manometer 350 are connected to one another via tubing 370, piping, or the like. For example, the vacuum pump 310 is connected to the flow regulator 320 by ⅜-inch tubing. The flow regulator 320 is connected to the filter 330 by ⅜-inch tubing. The filter 330 is connected to the vacuum canister 340 by ⅜-inch tubing. The vacuum canister 340 is connected to the manometer 350 by ¼-inch tubing. Furthermore, the manometer 350 is connected to the atmosphere (i.e., exposed to ambient pressure) by ¼-inch tubing extending between the manometer 350 and an opening 372 in a wall 360 of the housing. The tubing 370 allows air to flow between the components.

The vacuum pump 310, along with the flow regulator 320, is used to create a controlled airflow through the system 300. The filter 330 ensures the quality/integrity of the air flowing through the system 300. The filter 330 can be any type of air filter (whether known now or in the future) suitable for removing undesired particulates and contaminants from the air flowing through the system 300.

The fibrous material 346 in the reference muffler 344 causes a pressure drop (AP) in the vacuum canister 340, as the air flow is drawn through the fibrous material 346 at a particular flow rate. The manometer 350 (e.g., a digital pressure transducer) measures this pressure drop (ΔP) for the given flow rate, which represents the airflow resistivity R₁ of the fibrous material 346. Using the determined airflow resistivity value R₁, along with the value ρ for the density of the fibrous material 346, Equation (2) can be solved to determine the effective fiber diameter (d_{effective}) of the fibrous material 346, as described above. The system 300 can include dedicated processing logic (e.g., hardware and/or software) for performing these calculations. In some exemplary embodiments, the dedicated processing logic could be a general purpose computer programmed to perform the calculations. Alternatively, the system 300 could display or otherwise provide information on the pressure drop (ΔP), which a user could then input into a separate system, such as a general purpose computer programmed to perform the calculations.

Thereafter, the system 300 can determine the ratio of the known actual fiber diameter (d_{filament}) to the calculated effective fiber diameter (d_{effective}), which provides a percentage of texturization representing the average resulting fraction of fibers that were effectively separated from the roving. The system 300 multiplies this ratio by one hundred to determine a percent of texturization of the fibrous material 346, according to Equation (3) as described above. In some exemplary embodiments, the system 300 stores this information (and possibly intermediate calculations) for later retrieval/use.

Thus, the system 300 provides a consistent, repeatable, and accurate (e.g., within +/−7%) measure of the texturization of a fibrous material. The measurement can be used, for example, to gauge the acoustical performance of the fibrous material, to research changes in process variables on material performance, etc. For example, in one exemplary embodiment, the measurement is used to perform quality control during muffler filling operations. In this exemplary embodiment, if the texturized fiberglass being filled into a muffler is determined to have a degree of texturization below a desired threshold (e.g., 60%), the filled muffler is determined to be unsatisfactory. Thereafter, the system 300 could also be used to investigate the cause of the poor performance of the texturized material, such as by varying process variables/conditions one at a time and reassessing the degree of texturization after each variation.

The scope of the general inventive concepts are not intended to be limited to the particular exemplary embodiments shown and described herein. From the disclosure given, those skilled in the art will not only understand the general inventive concepts and their attendant advantages, but will also find apparent various changes and modifications to the methods and systems disclosed. It is sought, therefore, to cover all such changes and modifications as fall within the spirit and scope of the general inventive concepts, as described and claimed herein, and any equivalents thereof.

1. A method of quantifying a degree of texturization of a fibrous material, the method comprising:
providing a quantity of the fibrous material in a chamber;
introducing air into the chamber at a predetermine flow rate;
measuring a drop in pressure across the fibrous material at the flow rate;
using the drop in pressure to calculate an effective fiber diameter of the fibrous material; and
using the effective fiber diameter to determine the degree of texturization of the fibrous material,
wherein the degree of texturization is expressed as a ratio of an actual fiber diameter of the fibrous material to the effective fiber diameter of the fibrous material.

2. (canceled)

3. The method of claim 1, wherein the degree of texturization is expressed as a percentage calculated by multiplying the ratio by 100.

4. The method of claim 1, wherein the actual fiber diameter is within the range of 8 μm to 40 μm.

5. The method of claim 1, wherein the chamber is one of a production muffler and a reference muffler.

6. The method of claim 1, wherein the fibrous material is texturized fiberglass.

7. The method of claim 6, wherein the texturized fiberglass is formed by feeding a fiberglass roving through a texturizing nozzle.

8. The method of claim 1, further comprising:
feeding a fiberglass roving through a texturizing nozzle to form the fibrous material within a cavity of a muffler; and
relocating at least a portion of the fibrous material from the cavity to the chamber.

9. The method of claim 1, wherein the quantity of the fibrous material in the chamber has a fill density within the range of 80 g/L to 200 g/L.

10. A system for quantifying a degree of texturization of a fibrous material, the system comprising:
first means for holding a quantity of the fibrous material;
second means for drawing air through the fibrous material at a predetermine flow rate;
third means for measuring a drop in pressure across the fibrous material at the flow rate;
fourth means for calculating an effective fiber diameter of the fibrous material using the drop in pressure; and
fifth means for determining the degree of texturization of the fibrous material by solving the equation:
$$degree of texturization = \frac{{d}_{filament}}{{d}_{effective}} * 100. \qquad$$

11. The system of claim 10, wherein the first means is one of a production muffler and a reference muffler.

12. The system of claim 10, wherein the second means comprises a vacuum pump, a flow valve, and a flow meter.

13. The system of claim 10, wherein the third means comprises a manometer.

14. The system of claim 10, wherein the fourth means is a general purpose computer programmed to solve the equation:
$${d}_{effective} = \sqrt{\frac{3180 * {ρ}^{1.53}}{{R}_{1 , ideal}}} . \qquad$$

15. The system of claim 10, wherein the fifth means is a general purpose computer.

16. The system of claim 15, wherein the general purpose computer includes a display, and
wherein the degree of texturization is displayed on the display.

17. The system of claim 10, wherein the fibrous material is texturized fiberglass.

18. The system of claim 17, wherein the texturized fiberglass is formed by feeding a fiberglass roving through a texturizing nozzle.
